(19) United States
(12) Patent Application Publication
(10) Pub. No.: US 2012/0112487 A1
(43) Pub. Date: May 10, 2012

(54) Truck trunk cargo carrier

(76) Inventor: Victor Allen Wilson, Arlington, TX (US)

(21) Appl. No.: 12/925,988

(22) Filed: Nov. 4, 2010

(51) Int. Cl. B60R 9/055

(52) U.S. Cl. 296/37.6

(57) ABSTRACT

This invention is a self contained storage compartment designed specifically to be permanently attached to the bed of a private passenger pickup truck. It differs from similar apparatuses currently on the market in that it is of a size sufficient to transport large content that is typically transported in the trunk compartment of the private passenger automobile/car. It is lined with carpet to prevent items from sliding around within the compartment while the vehicle is in motion. It is designed with a weather sealed, lockable lid to secure and protect the contents within. This invention is designed to meet the needs of the non-commercial, retail private passenger truck owner. It is designed to meet the needs of pickup truck owners desiring storage space that protects transported goods from theft and elements of weather.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

This invention generally relates to permanently attached storage compartments or storage boxes used in the bed of private passenger pickup trucks. Pickup trucks have been and remain very attractive for use as work vehicles throughout the United States. Their popularity has continued to grow among the private sector as passenger vehicles. Many are designed with four doors and front and rear seats and are often used in a manner similar to that of the private passenger car (automobile). Many persons in the ‘work’ field such as painters, electricians, mechanics, plumbers, etc find pickup trucks especially useful to carry tools and other items necessary to carry out the duties of their profession. This invention however is designed to meet the needs of the retail consumer, i.e., home owner, college student, and other consumers desirous of driving a private passenger pickup but having need of the benefits provided by the trunk of a private passenger automobile.

There are many problems that arise out of the use of pickup trucks to transport items for tradesmen and the private sector. Some of the problems include exposure of cargo to elements of weather while in the open bed of a pickup. There also is a potential risk of theft of items left in the open bed of a pickup. Items left in the open bed of a pickup tend to slide/move around and are often damaged while the truck is being driven.

While there exist many devices or apparatuses to address some of the issues mentioned above, e.g. the camper shell, tool boxes, hard surface covers, and soft roll-up covers, they fall short of meeting the needs of the retail consumer in many aspects. Many of the devices currently on the market involve covering the entire bed of the truck. These devices prevent the user from using a portion of the truck bed to transport items that are too tall to fit under the truck bed cover. They also fail to prevent items from moving around in the bed of the truck while it is being driven. Items such as soft roll-up covers often lack a locking mechanism to sufficiently secure the cargo from theft. There are also items know as ‘tool boxes’ that are often used by tradesmen or contractors. These items prevent items from sliding around in the bed of the truck but often aren't sealed to totally keep out moisture and elements of weather. Most importantly, tool boxes fail to meet the needs of the retail consumer due to their shape and size. They are not built to sufficiently store and carry items typically transported by the retail consumer. Their design does not allow for use by consumers similar to that provided by the ‘trunk’ of a private passenger automobile/car. Their side and dimensions do not allow for the storage and transport of items such as large suitcases, garment bags/luggage and other items transported by the retail consumer.

### BRIEF SUMMARY OF THE INVENTION

The invention is a lockable hard surfaced cargo box with fabric lined interior walls. The invention is designed with a floor, four vertical walls attached perpendicular to the floor and perpendicular to each other so as to form a rectangular box shape and a lid designed to cover the top opening of the box. The lid is designed and to be attached with hinges along the side nearest the cab of the truck and having a keyed locking mechanism along one or more of the remaining three sides.

It is designed to be permanently mounted to the inside bed of a private passenger pickup truck. It is designed to be mounted adjacent to the front wall of the interior bed next to the rear window of the cab compartment of the pickup truck. It is designed to attach to the pickup truck bed floor or one or more of the three adjacent sides. The floor, walls and lid of the invention address the issues, problems, and concerns associated with cargo items moving/sliding around while the vehicle is in motion.

The Truck Trunk is designed to extend laterally across the bed of the pickup from one sidewall of the bed to the other and substantially from the front wall of the cab toward the rear wall/tailgate. The size and dimensions of the ‘Truck Trunk’ are designed to provide storage and transport similar to that of the trunk of a private passenger automobile. The size of the invention addresses and solves the problems associated with ‘tool boxes’ of not allowing sufficient space and access for storage, transport, and access to cargo items such as suitcases, garment bags and other items typically transported by the retail consumer.

The dimension and size of the invention also address the concern of allowing a sufficient portion of the bed of the pickup truck to remain open and available for the transport of taller cargo and items not needing the security of the cargo compartment.

The Truck Trunk is designed with an automobile trunk seal installed around the top edge of the cargo compartment box and under the lid. This sealant is to address the concern of protecting the cargo from rain, moisture and other elements of weather.

The design of the invention includes a keyed locking mechanism to prevent unwanted access to items stored within. The locking mechanism is designed to address the concern of theft of cargo and provides a measure of theft prevention.

The invention is designed with door struts to hold open the lid to allow for ease of input and removal of cargo. The installation of the door struts on opposite sides of the cargo box and attached to the lid provides access similar to that of the trunk of the private passenger automobile.

### BRIEF DESCRIPTION OF THE SEVERAL VIEWS OF THE DRAWINGS

FIG. 1 is an overhead view of the Truck Trunk with its lid closed while it's attached to the bed of a pickup truck.

FIG. 2 is a view of the Truck Trunk with its lid opened revealing the interior. This depiction shows the mounted struts, locking mechanism, rubber seal and hinges.

FIG. 3 is a frontal view of the Truck Trunk with its lid closed.

FIG. 4 is a side view of the Truck Trunk with its lid closed.

### DETAILED DESCRIPTION OF THE INVENTION

Now referencing specifically the drawings to aid in describing the present invention:

It is quite possible to construct or manufacture this invention using a variety of materials and methods. The invention is also susceptible to various modifications. The drawings depicting the invention and these subsequent detailed descriptions of the drawings are not intended to place limitations on the claims of the inventor. These drawings and their description are in no way intended to limit the invention to the specific form as disclosed. This invention is, however, intended to cover all modifications, methods, and alternative constructions and any subsequent equivalents within the spirit of the invention as described and claimed.

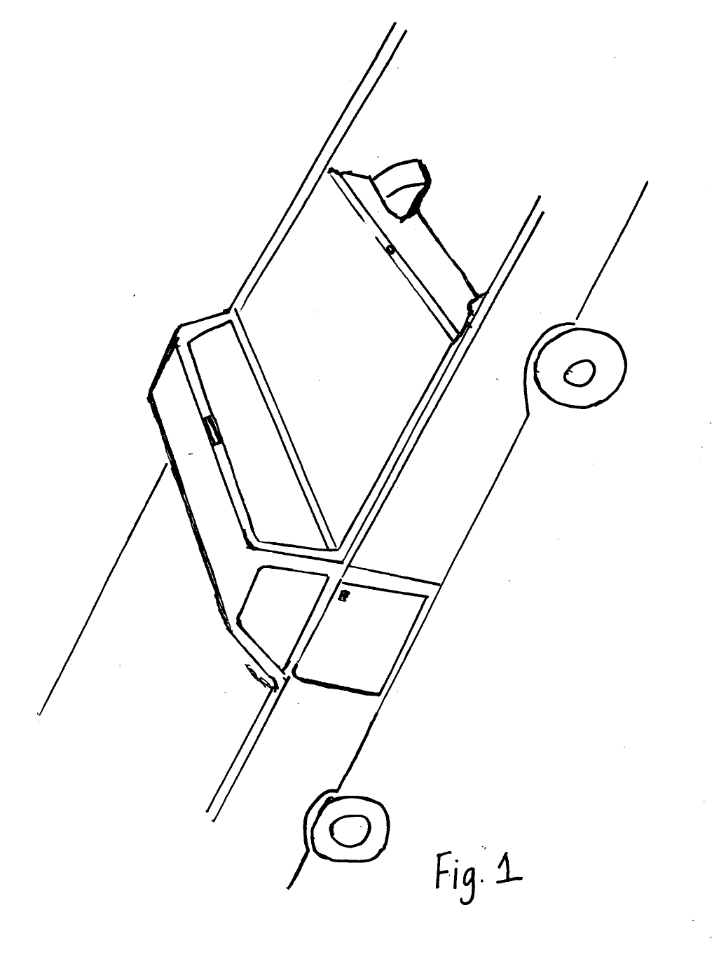

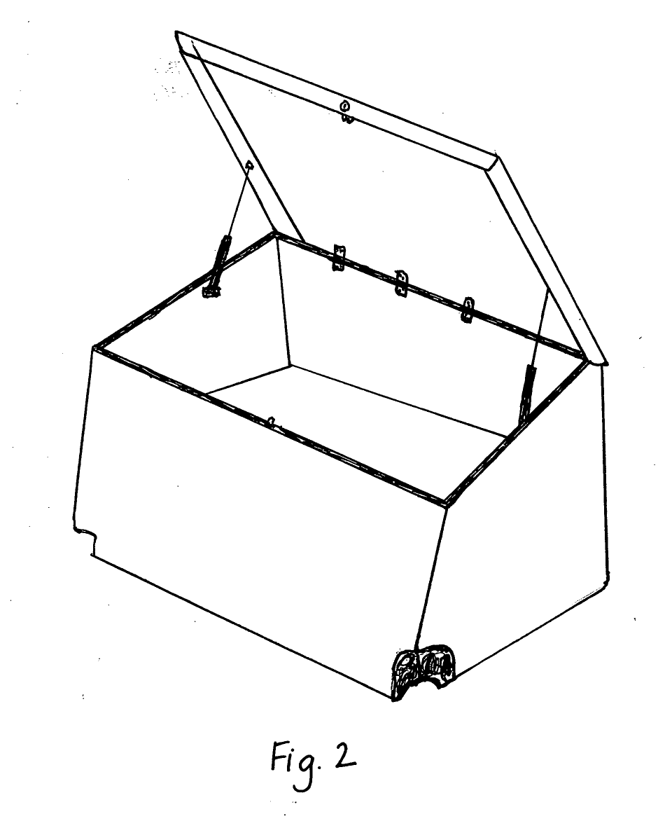

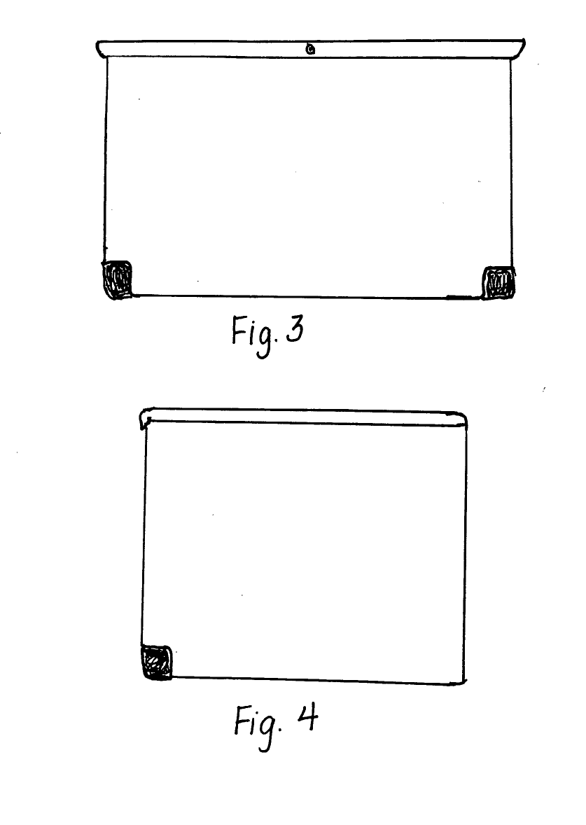

The Truck Trunk is to be constructed of a light weight durable material. The Truck Trunks' outer walls and lid, as seen in FIG. 1, FIG. 2, FIG. 3 and FIG. 4 are to be constructed of a lightweight solid material to provide for long lasting durability and protection of the contents held within. The preferred material of manufacture is light weight metal, sheet metal, aluminum, steel or a carbon fiber.

The interior of the Truck Trunk as seen in FIG. 2 is lined with carpet or fabric as often used in the truck space of the private passenger automobile/car. The fabric lining is attached to the walls using a durable weather resistant adhesive. Also depicted in FIG. 2 is the liftgate/door struts. The struts are attached to the side walls of the interior of the Truck Trunk and the lid. They are positioned to hold open the lid for placing and removing cargo. The top edge of the main body of the Truck Trunk shown in FIG. 2 is a depiction of the elastomeric seal. The seals placement and design is to prevent water, moisture and other elements from enter the interior of the Trunk. The connecting hinge system is also depicted in FIG. 2. The hinges connect the lid to the main body of the Trunk. They are placed on the interior of the Trunk to prevent removal and unauthorized entry into the Trunk. The keyed locking mechanism is also depicted in FIG. 2.

The exterior of the Truck Trunk as depicted in FIG. 3 and FIG. 4 shows the Truck Trunk with the lid closed. These Figures also show the cut out areas on the sides of the Truck Trunk to allow the Trunk to fit over the wheel wells of the pickup truck.

I claim:

1. A Storage Container/Cargo Trunk sufficiently large enough to cover approximately half the floor space of the bed of a private passenger pickup truck.

2. The apparatus of claim 1 having a hard surface lid attached to one side of the apparatus via a hinge system.

3. The apparatus of claim 1 having a locking mechanism on one or more sides. The locking mechanism operable via key and movable from locked and unlocked position to prevent the lid from unauthorized entry.

4. The apparatus of claim 1 comprises a pliable elastomeric seal secured about the top edge portion of the main body in such a manner as to fit snugly between the lid and main body while lid is in the down/closed position.

5. The apparatus of claim 1 having interior walls and surfaces lined with fabric/carpet.

6. The apparatus of claim 1 comprises two struts attached to opposite sides of the interior walls and connected to the lid of the apparatus.
